(19) United States
(12) Patent Application Publication
(10) Pub. No.: US 2014/0066544 A1
(43) Pub. Date: Mar. 6, 2014

(54) INSULATING COMPOSITION FOR MULTILAYER PRINTED CIRCUIT BOARD

(71) Applicant: SAMSUNG ELECTRO-MECHANICS CO., LTD., Suwon (KR)

(72) Inventors: Hyung Mi JUNG, Suwon (KR); Ji Hye SHIM, Suwon (KR); Kee Su JEON, Suwon (KR); Hwa Young LEE, Suwon (KR)

(73) Assignee: Samsung Electro-Mechanics Co., Ltd., Suwon (KR)

(21) Appl. No.: 13/800,465

(22) Filed: Mar. 13, 2013

(30) Foreign Application Priority Data
Sep. 4, 2012 (KR) 10-2012-0097617

(51) Int. Cl. H01B 3/40

(52) U.S. Cl. CPC H01B 3/40
USPC 523/429; 523/427

(57) ABSTRACT

The present invention relates to an interlayer insulating composition for a multilayer printed wiring board including: an epoxy resin including a naphthalene-modified epoxy resin, a cresol novolac epoxy resin, and a rubber-modified epoxy resin; a thermoplastic resin; a curing agent; and an inorganic filler and a multilayer printed wiring board including the same as an insulating layer. The present invention can provide an insulating composition excellent in adhesion between an insulating layer and a Cu layer to secure normal operation and reliability of a final substrate. Further, since the present invention properly includes an epoxy resin and a thermoplastic resin regardless of an increase in the content of an inorganic filler, it is possible to secure the reliability of the substrate by preventing an insulating film from being brittle and improving toughness of the insulating film while maintaining a low thermal expansion rate.

### CROSS-REFERENCE TO RELATED APPLICATIONS

Claim and incorporate by reference domestic priority application and foreign priority application as follows:

“CROSS REFERENCE TO RELATED APPLICATION

This application claims the benefit under 35 U.S.C. Section 119 of Korean Patent Application Serial No. 10-2012-0097617, entitled filed Sep. 4, 2012, which is hereby incorporated by reference in its entirety into this application.”

### BACKGROUND OF THE INVENTION

1. Field of the Invention

The present invention relates to an insulating composition for a multilayer printed circuit board and a multilayer printed circuit board comprising a prepreg and an insulating film using the insulating composition as an insulating layer.

2. Description of the Related Art

A printed circuit board (PCB) is basically manufactured by insulating between inner circuits made of copper (Cu) with a polymer composite material to form a multilayer substrate. A resin composition mainly used in an insulating layer of the multilayer printed wiring board is prepared by mixing an inorganic filler with an epoxy resin and a curing agent for mechanical strength and thermal characteristics.

With the recent trend toward miniaturization and high performance of electronic devices, there are demands for suppression of a thermal expansion rate and improvement of mechanical strength of a substrate material. Therefore, the content of the inorganic filler with relatively high physical strength and heat-resistance is increased.

However, when the content of the inorganic filler is increased than that of the epoxy resin, adhesion between an insulating layer and a Cu layer is deteriorated.

Further, when increasing the content of the inorganic filler (for example, silica) to suppress the thermal expansion rate of the substrate, the thermal expansion rate is reduced as in the following FIG. 1, but elongation characteristics are deteriorated as in the following FIG. 2 and peel strength is reduced.

Due to this, there is a difficulty in forming a reliable interlayer insulating layer since the film is brittle and the adhesion with Cu is deteriorated.

### RELATED ART DOCUMENT

### Patent Document

Patent Document 1: Japanese Patent Laid-Open No. JP 2004-231788

### SUMMARY OF THE INVENTION

The present invention has been invented in order to overcome the above-described problems and it is, therefore, an object of the present invention to provide an interlayer insulating composition for a multilayer printed wiring board excellent in adhesion between an insulating layer and a Cu layer to secure normal operation and reliability of a final substrate.

Further, it is another object of the present invention to provide an interlayer insulating composition for a multilayer printed wiring board that can improve toughness of an insulating layer by overcoming brittle characteristics of the insulating layer due to an increase in the content of an inorganic filler.

Further, it is still another object of the present invention to provide a prepreg and an insulating film using an insulating composition.

Further, it is still another object of the present invention to provide a multilayer printed wiring board comprising a prepreg and an insulating film using an insulating composition as an interlayer insulating layer.

In accordance with one aspect of the present invention to achieve the object, there is provided an interlayer insulating composition for a multilayer printed wiring board including: an epoxy resin including a naphthalene-modified epoxy resin, a cresol novolac epoxy resin, and a rubber-modified epoxy resin; a thermoplastic resin; a curing agent; and an inorganic filler.

It is preferred that the epoxy resin includes the naphthalene-modified epoxy resin 30 to 50 wt %, the cresol novolac epoxy resin 30 to 50 wt %, and the rubber-modified epoxy resin 10 to 30 wt %.

It is preferred that an average epoxy equivalent of the naphthalene-modified epoxy resin is 100 to 500, an average epoxy equivalent of the cresol novolac epoxy resin is 200 to 600, and an average epoxy equivalent of the rubber-modified epoxy resin is 100 to 500.

It is preferred that a weight average molecular weight of the thermoplastic resin is greater than 100,000.

It is preferred that the thermoplastic resin is included in an amount of 1 to 20 parts by weight based on the sum of the contents of the epoxy resin and the curing agent.

It is preferred that the thermoplastic resin is at least one selected from a polyvinyl acetal resin, a phenoxy resin, a polyimide resin, a polyamideimide resin, a polyetherimide resin, a polysulfone resin, a polyethersulfone resin, a polyphenyleneether resin, a polycarbonate resin, a polyether ether ketone resin, a polyester resin, and a polyacetal resin.

In accordance with an embodiment of the present invention, it is preferred that the thermoplastic resin is a polyvinyl acetal resin having a functional group which can chelate with copper (Cu) of the printed wiring board.

The chelatable functional group may be selected from a carboxyl group, a carbonyl group, and an ether group.

The chelatable functional group may be included in the polyvinyl acetal resin in an amount of 0.1 to 2 mol %.

It is preferred that the inorganic filler is included in an amount of 30 to 80 wt % based on 100 wt % as the sum of the contents of the epoxy resin and the curing agent.

It is preferred that the inorganic filler has a diameter of 0.05 to 5 μm.

The inorganic filler may be at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof.

It is preferred that the curing agent is an amino triazine novolac compound having an intramolecular nitrogen (N) content of 6 to 20 wt %.

Additionally, the composition may further include at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

Further, in accordance with another aspect of the present invention to achieve the object, there is provided a prepreg or an insulating film using an insulating composition.

Further, in accordance with still another aspect of the present invention to achieve the object, there is provided a multilayer printed circuit board including a prepreg or an insulating film using an insulating composition as an interlayer insulating layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 shows changes in coefficient of thermal expansion (CTE) according to the content of an inorganic filler (silica);

FIG. 2 shows changes in Young's modulus and elongation according to the content of the inorganic filler (silica);

FIG. 3 is a graph of tensile stress-tensile strain according to whether a thermoplastic resin is added or not (embodiment 2, comparative example 2);

FIG. 4 shows changes in peel strength according to whether the thermoplastic resin is added or not (embodiment 2, comparative example 2); and

FIG. 5 shows changes in tensile strength and peel strength according to whether the thermoplastic resin and rubber are added or not.

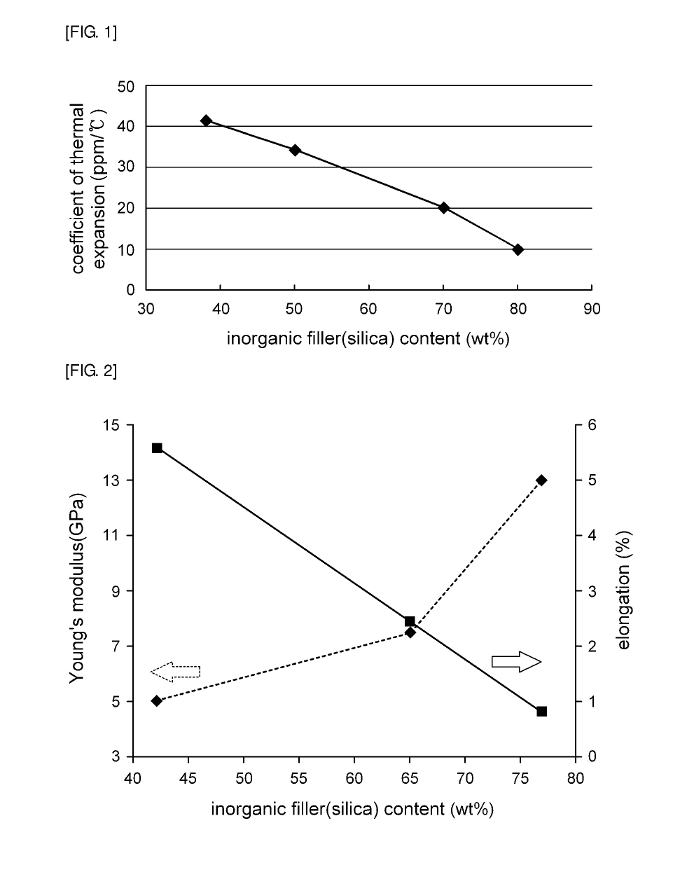

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

A composition for interlayer insulation of a multilayer wiring board in accordance with the present invention includes an epoxy resin including a naphthalene-modified epoxy resin, a cresol novolac epoxy resin, and a rubber-modified epoxy resin, a thermoplastic resin, a curing agent, and an inorganic filler.

The base resin included in the insulating composition of the present invention is characterized by using a mixture of three kinds of epoxy resins. Specifically, the epoxy resin including a naphthalene-modified epoxy resin, a cresol novolac epoxy resin, and a rubber-modified epoxy resin is used. As the three kinds of epoxy resins are used, it is preferred since it is possible to satisfy mechanical properties of a film while reducing a coefficient of thermal expansion.

It is preferred that the epoxy resin of the present invention includes a naphthalene-modified epoxy resin 30 to 50 wt %, a cresol novolac epoxy resin 30 to 50 wt %, and a rubber-modified epoxy resin 10 to 30 wt %. When the content of the epoxy resin is out of the above range, it is not preferred since the mechanical properties of the film are deteriorated or the coefficient of thermal expansion is increased.

It is preferred that an average epoxy equivalent of the naphthalene-modified epoxy resin is 100 to 500 in the sense that a bond distance on a cured structure is shortened to reduce the coefficient of thermal expansion.

Further, it is preferred that an average epoxy equivalent of the cresol novolac epoxy resin is 200 to 600 in terms of mechanical toughness of the film after curing.

It is preferred that an average epoxy equivalent of the rubber-modified epoxy resin is 100 to 500 in terms of elongation of the film after curing.

Further, in the present invention, it is preferred to include various thermoplastic resins to increase toughness of an insulating layer. A weight average molecular weight of the thermoplastic resin is greater than 100,000, preferably 100,000 to 500,000 in terms of improvement of elongation and adhesion with Cu.

It is preferred that the thermoplastic resin of the present invention is included in an amount of 1 to 20 parts by weight based on the sum of the contents of the epoxy resin and the curing agent in terms of improvement of elongation and adhesion with Cu.

For a concrete example, the thermoplastic resin is at least one selected from a polyvinyl acetal resin, a phenoxy resin, a polyimide resin, a polyamideimide resin, a polyetherimide resin, a polysulfone resin, a polyethersulfone resin, a polyphenyleneether resin, a polycarbonate resin, a polyether ether ketone resin, a polyester resin, and a polyacetal resin. Among them, a polyvinyl acetal resin is most preferable.

Further, when a polyvinyl acetal resin is used as the thermoplastic resin in accordance with the present invention, it is preferred that a functional group, which can chelate with copper (Cu), is included in the polyvinyl acetal resin. Preferably, the functional group, which can chelate with copper (Cu), is a carboxyl group, a carbonyl group, an ether group, etc, and a carboxyl group is most preferable.

It is preferred that the functional group, which can chelate with copper (Cu), is included in the polyvinyl acetal resin in an amount of 0.1 to 2 mol %.

The present invention uses a polyvinyl acetal resin including a functional group, which can chelate with copper, as the thermoplastic resin to improve adhesion with a copper layer.

Further, the present invention uses the inorganic filler to reduce the expansion rate of the insulating composition. It is preferred that the inorganic filler is included in an amount of 30 to 80 wt % based on 100 wt % as the sum of the contents of the epoxy resin and the curing agent. When the content of the inorganic filler is less than 30 wt %, the coefficient of thermal expansion is increased. Further, when the content of the inorganic filler exceeds 80 wt %, it is not preferred since it is difficult to be applied to substrate processes such as lamination due to the brittle mechanical characteristics of the film and deterioration of flowability of the film.

It is preferred that the inorganic filler in accordance with the present invention has a diameter of 0.05 to 5.0 μm in terms of the mechanical characteristics of the film and film roughness and adhesion with Cu after the substrate processes.

The inorganic filler may be at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof.

Further, the curing agent for curing of the epoxy resin is represented as the following chemical formula 1, and an amino triazine novolac compound having an intramolecular nitrogen (N) content of 6 to 20 wt % is preferable.

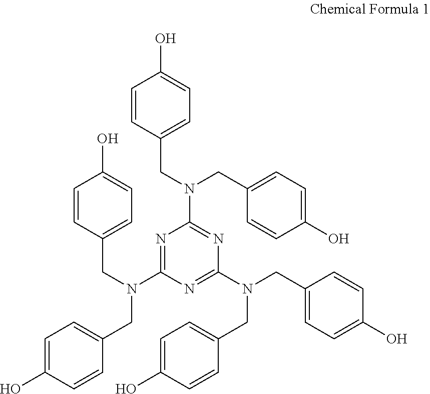 [SMILES: Oc1ccc(CN(Cc2ccc(O)cc2)c2nc(N(Cc3ccc(O)cc3)Cc3ccc(O)cc3)nc(N(Cc3ccc(O)cc3)Cc3ccc(O)cc3)n2)cc1]

The curing accelerator is preferably an imidazole compound, more preferably at least one compound selected from the group consisting of 2-ethyl-4-methyl imidazole, 1-(2-cyanoethyl)-2-alkyl imidazole, 2-phenyl imidazole, and mixtures thereof but is not particularly limited thereto.

Additionally, in order to improve processability, the insulating composition in accordance with the present invention may further include at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

It is preferred that the rubber component is included in an amount of greater than 5 wt % based on 100 wt % as the sum of the contents of the epoxy resin and the curing agent in terms of the mechanical properties (elongation) of the film.

Further, unless deteriorating the properties desired in the present invention, the present invention may include other curing agent, curing accelerator, leveling agent, flame retardant, etc according to the need in addition to the composition listed above. Further, the insulating composition in accordance with the present invention may further include at least one additive such as a filler, a softener, a plasticizer, an antioxidant, a flame retardant, an auxiliary flame retardant, a lubricant, an antistatic agent, a coloring agent, a heat stabilizer, a light stabilizer, a UV absorber, a coupling agent, or an anti-settling agent.

Further, in accordance with an embodiment of the present invention, a prepreg using the insulating composition may be provided.

The prepreg may be prepared by applying the insulating composition to a reinforcing material or impregnating the insulating composition into the reinforcing material, curing the insulating composition, and drying the insulating composition to remove a solvent. For example, the impregnation method may be dip coating, roll coating, etc.

For example, the reinforcing material may be woven glass cloth, woven alumina glass fibers, glass fiber non-woven fabrics, cellulose non-woven fabrics, woven carbon fibers, polymer fabrics, etc. Further, the reinforcing material may be glass fibers, silica glass fibers, carbon fibers, alumina fibers, silicon carbide fibers, asbestos, rock wool, mineral wool, gypsum whisker, and woven fabrics or non-woven fabrics thereof, aromatic polyamide fibers, polyimide fibers, liquid crystal polyester, polyester fibers, fluoride fibers, polybenzoxazole fibers, glass fibers with polyamide fibers, glass fibers with carbon fibers, glass fibers with polyimide fibers, glass fibers with aromatic polyester, glass paper, mica paper, alumina paper, kraft paper, cotton paper, and paper-glass combined paper.

The prepreg in accordance with the present invention may be combined with copper. That is, the prepreg, which is prepared by performing a heat treatment process in a semi-cured state after impregnating the insulating composition into the reinforcing material, may be heat-treated after being positioned on a copper foil. When removing the solvent and performing the heat treatment, a member obtained by combining the copper and the prepreg is manufactured. The solvent may be evaporated by methods such as heating under reduced pressure or ventilation. For example, the application method may be roller coating, dip coating, spray coating, spin coating, curtain coating, slit coating, screen coating, etc.

Further, in accordance with an embodiment of the present invention, an insulating film may be formed using a solution of the insulating composition. Specifically, a film may be formed on a substrate by forming a solution layer of the insulating composition through solvent casting and removing a solvent from the solution layer. The substrate may be a metal foil such as a copper foil, an aluminum foil, a gold foil, or a silver foil, a glass substrate, a PET film, etc.

Further, in accordance with the present invention, a printed circuit board including a prepreg and an insulating film, which are prepared using the insulating composition, as an insulating layer is provided. The printed circuit board may consist of a film, a print board, a copper clad laminate, a prepreg, or combinations thereof. The printed circuit board may be a copper clad laminate (CCL) or a flexible CCL.

The printed circuit board may be used by being modified variously. A conductor pattern may be formed on one or both surfaces of the printed circuit board, and the conductor pattern may be formed in a multilayer structure such as four layers or eight layers.

Hereinafter, preferred embodiments of the present invention will be described in detail.

The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Comparative Example 1

After adding 500 g of a naphthalene epoxy resin (SE-80), 500 g of a cresol novolac epoxy resin (Kukdo Chemical Co., LTD, YDCN-500-01P), 779 g of an amino triazine novolac curing agent (GUN EI Chemical Industry Co., LTD, PS-6313) having a concentration of 66.7 wt % in 2-methoxyethanol as a solvent, and 3665.2 g of spherical silica slurry having a concentration of 77 wt % in DMAc as a solvent and a size distribution of 0.1 to 1.2 μm, the mixture is stirred at 300 rpm for 3 hours. 2.5 g of 2-ethyl-4-methyl imidazole as an initiator and 81.85 g of BYK-337 as a surface improvement additive are added to the mixture and additionally mixed at 300 rpm for 1 hour to prepare an insulating composition.

### Comparative Example 2

The insulating composition prepared according to the comparative example 1 is casted on a PET film to be manufactured into a roll type product. The manufactured product is laminated at 100° C. with a size of 405 mm×510 mm. The product is cured at 110° C. for 30 minutes after lamination, desmeared to form a roughness, and subjected to an electroplating process to form a circuit layer with a thickness of about 25 μm. The circuit layer is cured at 190° C. for 1 hour to complete a final cured product.

### Embodiment 1

After adding 400 g of a naphthalene epoxy resin (SE-80, epoxy equivalent 146.6), 400 g of a cresol novolac epoxy resin (Kukdo Chemical Co., LTD, YDCN-500-01 P, epoxy equivalent 206), 200 g of a rubber-modified epoxy resin (STRUKTOL, Polydis 3616, epoxy equivalent 300), 710.52 g of an amino triazine novolac curing agent (GUN EI Chemical Industry Co., LTD, PS-6313, intramolecular nitrogen content 18.9 wt %) having a concentration of 66.7 wt % in 2-methoxyethanol as a solvent, and 3732.65 g of spherical silica slurry having a concentration of 77 wt % based on 100 wt % as the sum of the contents of the epoxy resins and the curing agent in DMAc as a solvent and a size distribution of 0.05 to 5 μm, the mixture is stirred at 300 rpm for 3 hours.

After additionally adding 147.3 g of a thermoplastic resin (polyvinyl acetal resin, Sekisui HRS, weight average molecular weight 100,000, carboxyl functional group content 0.2 mol %), which is 10 parts by weight (phr) based on the sum of the contents of the epoxy and the curing agent, 2.5 g of 2-ethyl-4-methyl imidazole as an initiator, and 92.89 g of BYK-337 as a surface improvement additive to the mixture, the mixture is additionally mixed at 300 rpm for 1 hour to prepare an insulating composition.

### Embodiment 2

Except for using the insulating composition prepared according to the embodiment 1, a final cured product is completed in the same manner as the comparative example 2.

### Experimental Example 1

### Measurement of Properties

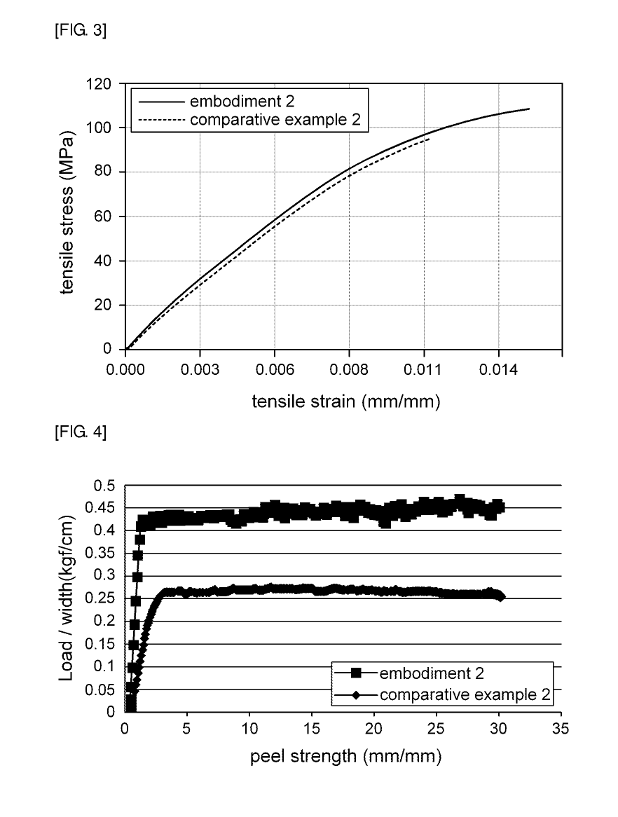

Properties of the cured products manufactured according to the comparative example 2 and the embodiment 2 are measured as follows, and the results thereof are shown in the following table 1. Further, graphs of tensile strength and peel strength thereof are shown in the following FIGS. 3 and 4.

TABLE 1

| | Comparative Example 2 | Embodiment 2 |
|---|---|---|
| Elongation (%) | 0.76 | 1.37 |
| Tensile strength [MPa] | 81.59 | 100.72 |
| Peel strength [kgf/cm] | 0.20 | 0.44 |
| Ra [μm] | 0.324 | 0.287 |

As in the results of the table 1, the cured product of the embodiment 2 of the present invention, which uses the mixture of the three kinds of epoxy resins and includes the thermoplastic resin, is excellent in elongation, tensile strength, and peel strength compared to the comparative example 2.

Further, as can be seen from the graphs of tensile strength and peel strength of the following FIGS. 3 and 4, the embodiment 2 of the present invention, which includes the thermoplastic resin, is excellent in tensile strength and peel strength compared to the comparative example 2, which does not include the thermoplastic resin.

### Embodiment 3

Except for changing the content of the thermoplastic resin (polyvinyl acetal) and rubber as in the following table 2 when preparing the insulating composition of the embodiment 1, an insulating composition and a cured product are manufactured in the same manner as the embodiments 1 and 2.

### Experimental Example 2

### Measurement of Properties

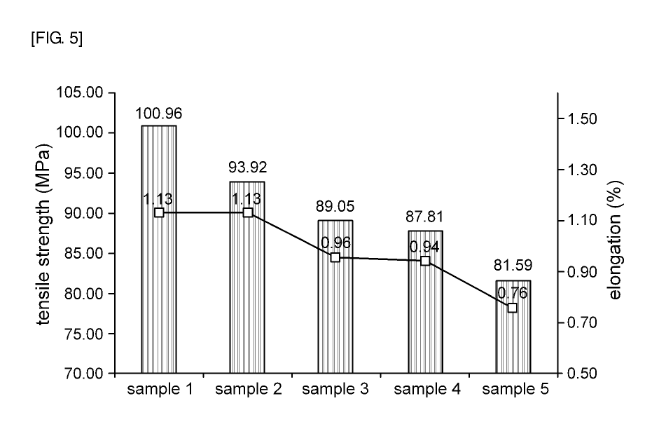

Tensile strength and elongation of the cured product manufactured in the embodiment 3 are measured, and the results thereof are shown in the following table 2 and FIG. 5.

TABLE 2

| Sample | 1 | 2 | 3* | 4* | 5* |
|---|---|---|---|---|---|
| Thermoplastic | 20 | 5 | 0 | 0 | 0 |
| resin (wt %) | | | | | |
| Rubber (wt %) | 20 | 20 | 20 | 10 | 0 |
| Tensile | 100.96 | 93.92 | 89.05 | 87.81 | 81.59 |
| strength | | | | | |
| (MPa) | | | | | |
| Elongation | 1.13 | 1.13 | 0.96 | 0.94 | 0.76 |
| (%) | | | | | |

*out of the range of the present invention

Referring to the table 2 and FIG. 5, the samples 1 and 2, which include both of the thermoplastic resin and the rubber, are improved in both of the tensile strength and the elongation compared to the sample 5 which does not include the thermoplastic resin and the rubber.

From these results, it is possible to know that an insulating composition including a thermoplastic resin and rubber is more effective in improvement of mechanical properties.

According to the present invention, it is possible to provide an insulating composition excellent in adhesion between an insulating layer and a Cu layer to secure normal operation and reliability of a final substrate.

Further, since the present invention properly includes an epoxy resin and a thermoplastic resin regardless of an increase in the content of an inorganic filler, it is possible to secure the reliability of the substrate by preventing an insulating film from being brittle and improving toughness of the insulating film while maintaining a low thermal expansion rate.

What is claimed is:

1. An interlayer insulating composition for a multilayer printed wiring board, comprising:
an epoxy resin including a naphthalene-modified epoxy resin, a cresol novolac epoxy resin, and a rubber-modified epoxy resin;
a thermoplastic resin;
a curing agent; and
an inorganic filler.

2. The interlayer insulating composition for a multilayer printed wiring board according to claim 1, wherein the epoxy resin includes the naphthalene-modified epoxy resin 30 to 50 wt %, the cresol novolac epoxy resin 30 to 50 wt %, and the rubber-modified epoxy resin 10 to 30 wt %.

3. The interlayer insulating composition for a multilayer printed wiring board according to claim 1, wherein an average epoxy equivalent of the naphthalene-modified epoxy resin is 100 to 500, an average epoxy equivalent of the cresol novolac epoxy resin is 200 to 600, and an average epoxy equivalent of the rubber-modified epoxy resin is 100 to 500.

4. The interlayer insulating composition for a multilayer printed wiring board according to claim 1, wherein a weight average molecular weight of the thermoplastic resin is greater than 100,000.

5. The interlayer insulating composition for a multilayer printed wiring board according to claim 1, wherein the thermoplastic resin is included in an amount of 1 to 20 parts by weight based on the sum of the contents of the epoxy resin and the curing agent.

6. The interlayer insulating composition for a multilayer printed wiring board according to claim 1, wherein the thermoplastic resin is at least one selected from a polyvinyl acetal resin, a phenoxy resin, a polyimide resin, a polyamideimide resin, a polyetherimide resin, a polysulfone resin, a polyethersulfone resin, a polyphenyleneether resin, a polycarbonate resin, a polyether ether ketone resin, a polyester resin, and a polyacetal resin.

7. The interlayer insulating composition for a multilayer printed wiring board according to claim 1, wherein the thermoplastic resin is a polyvinyl acetal resin having a functional group which can chelate with copper (Cu) of the printed wiring board.

8. The interlayer insulating composition for a multilayer printed wiring board according to claim 7, wherein the chelatable functional group is selected from a carboxyl group, a carbonyl group, and an ether group.

9. The interlayer insulating composition for a multilayer printed wiring board according to claim 7, wherein the chelatable functional group is included in the polyvinyl acetal resin in an amount of 0.1 to 2 mol %.

10. The interlayer insulating composition for a multilayer printed wiring board according to claim 1, wherein the inorganic filler is included in an amount of 30 to 80 wt % based on 100 wt % as the sum of the contents of the epoxy resin and the curing agent.

11. The interlayer insulating composition for a multilayer printed wiring board according to claim 1, wherein the inorganic filler has a diameter of 0.05 to 5 μm.

12. The interlayer insulating composition for a multilayer printed wiring board according to claim 1, wherein the inorganic filler is at least one selected from the group consisting of natural silica, fused silica, amorphous silica, hollow silica, aluminum hydroxide, boehmite, magnesium hydroxide, molybdenum oxide, zinc molybdate, zinc borate, zinc stannate, aluminum borate, potassium titanate, magnesium sulfate, silicon carbide, zinc oxide, boron nitride (BN), silicon nitride, silicon oxide, aluminum titanate, barium titanate, barium strontium titanate, aluminum oxide, alumina, clay, kaoline, talc, calcined clay, calcined kaoline, calcined talc, mica, short glass fibers, and mixtures thereof.

13. The interlayer insulating composition for a multilayer printed wiring board according to claim 1, additionally further comprising: at least one rubber component selected from the group consisting of elastomers such as polyurethane resins, polybutadiene, butadiene-acrylonitrile copolymers, polychloroprene, butadiene-styrene copolymers, polyisoprene, butyl rubber, fluorinated rubber, and natural rubber, styrene-isoprene rubber, acrylic rubber, epoxidized butadiene, and maleated butadiene.

14. The interlayer insulating composition for a multilayer printed wiring board according to claim 13, wherein the curing agent is an amino triazine novolac compound having an intramolecular nitrogen (N) content of 6 to 20 wt %.
